(19) United States
(12) Patent Application Publication
(10) Pub. No.: US 2010/0045884 A1
(43) Pub. Date: Feb. 25, 2010

(54) Liquid Crystal Display

(76) Inventors: Soon-Il AHN, Cheonan-si (KR); Dong-Gyu KIM, Yongin-si (KR); Hye-Seok NA, Seoul (KR)

Correspondence Address: HAYNES AND BOONE, LLP;IP Section, 2323 Victory Avenue, Suite 700, Dallas, TX, 75219, US

(21) Appl. No.: 12/537,143

(22) Filed: Aug. 6, 2009

(30) Foreign Application Priority Data
Aug. 25, 2008 (KR) 10-2008-0082853

(51) Int. Cl. G09G 3/36; G02F 1/133

(52) U.S. Cl. 349/37; 349/33; 349/141

(57) ABSTRACT

A liquid crystal display according to an embodiment includes a gate line extending in a first direction, a data line intersecting the gate line and extending in a second direction, a first switching element connected to the gate line and the data line, a second switching element connected to the gate line and the data line, a first subpixel electrode connected to the first switching element and having a first voltage, and a second subpixel electrode connected to the second switching element and having a second voltage. The difference between the first voltage and a common voltage is larger than the difference between the second voltage and the common voltage, and the shortest distance between the first subpixel electrode and the data line is larger than the shortest distance between the second subpixel electrode and the data line. Accordingly, a variation of luminance due to parasitic capacitance between the pixel electrode and the data line may be reduced, and the aperture ratio may be increased.

### CROSS-REFERENCE TO RELATED APPLICATION

This application claims priority to and the benefit of Korean Patent Application No. 10-2008-0082853, filed in the Korean Intellectual Property Office on Aug. 25, 2008, the entire contents of which are incorporated herein by reference.

### BACKGROUND

(a) Technical Field

The present disclosure relates to a liquid crystal display.

(b) Related Art

A liquid crystal display (LCD) is one of the most widely used flat panel displays (FPD). An LCD may include two display panels on which field generating electrodes are formed and a liquid crystal layer interposed between the two display panels. A voltage is applied to the field generating electrodes to generate an electric field on the liquid crystal layer. The generated electric field determines the orientation of liquid crystal molecules of the liquid crystal layer and controls the polarization of incident light, to display an image.

The liquid crystal display also includes a plurality of thin film transistors connected to the pixel electrodes and a plurality of signal lines, such as gate lines and data lines, for controlling the thin film transistors to apply a voltage to the pixel electrodes.

Among LCDs, a vertical alignment (VA) mode LCD, which aligns LC molecules such that the long axes of the LC molecules are perpendicular to the panels in the absence of an electric field, has a relatively high contrast ratio and wide reference viewing angle. A reference viewing angle is defined as a viewing angle that makes the contrast ratio equal to 1:10 or as a limit angle for inversion in luminance between the grays.

The VA mode liquid crystal displays divide one pixel into two subpixels and apply different voltages to the subpixels so that transmittance is changed and side visibility may be improved to be close to front visibility.

In this method, the voltages of two subpixels are controlled by using storage capacitors for providing side visibility close to that of front visibility. However, the structure and the driving method may be more complicated than desired such that it may be difficult to apply this method.

The above information disclosed in this Background section is only for enhancement of understanding of the background of the disclosure and therefore it may contain information that does not form the prior art that is already known in this country to a person of ordinary skill in the art.

### SUMMARY

One or more embodiments of the present disclosure relate to a structure and method for controlling the voltages of two subpixels. The structure and method of the present disclosure may reduce a change of luminance due to parasitic capacitance generated between a data line and a pixel electrode. The structure and method of the present disclosure may increase the aperture ratio of a liquid crystal display.

In an embodiment, a liquid crystal display may include a gate line extending in a first direction and a data line intersecting the gate line and extending in a second direction. A first switching element may be connected to the gate line and the data line and a second switching element may be connected to the gate line and the data line. A first subpixel electrode is connected to the first switching element and has a first voltage and a second subpixel electrode is connected to the second switching element and has a second voltage. The difference between the first voltage and a common voltage is larger than the difference between the second voltage and the common voltage, and the shortest distance between the first subpixel electrode and the data line is larger than the shortest distance between the second subpixel electrode and the data line.

The first subpixel electrode and the second subpixel electrode together may have a generally rectangular combined shape having a long edge in the first direction.

The liquid crystal display may further include a storage electrode line overlapping the first and second subpixel electrodes, wherein an overlapping area between the first subpixel electrode and the storage electrode line is smaller than an overlapping area between the second subpixel electrode and the storage electrode line.

The data line may transmit the data voltage with positive or negative polarities for the common electrode. The voltage of the storage electrode line may be repeatedly increased and decreased, and the voltage value may vary in the same direction as the polarity of the data voltage after the data voltage is applied to the first and second subpixel electrodes. The second subpixel electrode may overlap the data line. The data line may be bent for the distance between the second subpixel electrode and the data line to be varied.

The data line may include a first portion overlapping the second subpixel electrode and a second portion not overlapping the second subpixel electrode. The entire first portion of the data line may overlap the second subpixel electrode.

The storage electrode line may extend in the second direction. The storage electrode line may include a protrusion overlapping the second subpixel electrode.

The first subpixel electrode may be an isosceles trapezoid. The second subpixel electrode may be disposed outside two oblique edges of the first subpixel electrode and may include two electrode pieces with a right trapezoid arranged in symmetry. The first subpixel electrode and the second subpixel electrode may respectively be symmetrical with respect to the storage electrode line. At least one of the first subpixel electrode and the second subpixel electrode may have a cutout extending in the direction forming an oblique angle with the first and second directions.

A liquid crystal display according to another exemplary embodiment may include a gate line extending in a first direction, a data line intersecting the gate line and extending in a second direction, a storage electrode line extending in the second direction and applied with a varying voltage magnitude, a first switching element connected to the gate line and the data line, a second switching element connected to the gate line and the data line; a first liquid crystal capacitor connected to the first switching element and having a first voltage, a second liquid crystal capacitor connected to the second switching element and having a second voltage, a first storage capacitor connected between the first switching element and the storage electrode line, and a second storage capacitor connected between the second switching element and the storage electrode line and having a larger capacitance than the first storage capacitor. The first liquid crystal capacitor may include a first subpixel electrode connected to the first switching element, the second liquid crystal capacitor includes a second subpixel electrode connected to the second switching element and separated from the first subpixel electrode via a gap, and the shortest distance between the first subpixel electrode and the data line is larger than the shortest distance between the second subpixel electrode and the data line.

The first subpixel electrode and the second subpixel electrode together may have a generally rectangular combined shape having a long edge in the first direction. The voltage of the storage electrode line may repeatedly vary, and the value of the voltage varies in the same direction as the voltage polarity of the first and second liquid crystal capacitors immediately after the first and second liquid crystal capacitors are charged. The second subpixel electrode may overlap the data line.

The data line may be bent for the distance between the second subpixel electrode and the data line to be varied. The data line may include a first portion overlapping the second subpixel electrode and a second portion not overlapping the second subpixel electrode, and the entire first portion of the data line overlaps the second subpixel electrode.

### BRIEF DESCRIPTION OF THE DRAWINGS

FIG. 1 is a block diagram of an exemplary embodiment of a liquid crystal display.

FIG. 2 is a view showing a structure of an exemplary embodiment of a liquid crystal display and an equivalent circuit of three subpixels.

FIG. 3 is an equivalent circuit diagram of two pixels of an exemplary embodiment of a liquid crystal display.

FIG. 4 is a waveform diagram of a driving voltage of an exemplary embodiment of a liquid crystal display.

FIG. 5 is an equivalent circuit diagram of two pixels of an exemplary embodiment of a liquid crystal display.

FIG. 6 is a waveform diagram of an exemplary embodiment of a driving voltage of a liquid crystal display shown in FIG. 5.

FIG. 7 is an equivalent circuit diagram of two pixels of an exemplary embodiment of a liquid crystal.

FIG. 8 is a waveform diagram of voltages of an exemplary embodiment of a liquid crystal display shown in FIG. 7.

### DETAILED DESCRIPTION

Exemplary embodiments of the present disclosure are described more fully below with reference to the accompanying drawings, in which exemplary embodiments of the invention are shown. As those skilled in the art would realize, the described embodiments may be modified in various different ways, all without departing from the spirit or scope of the present disclosure.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

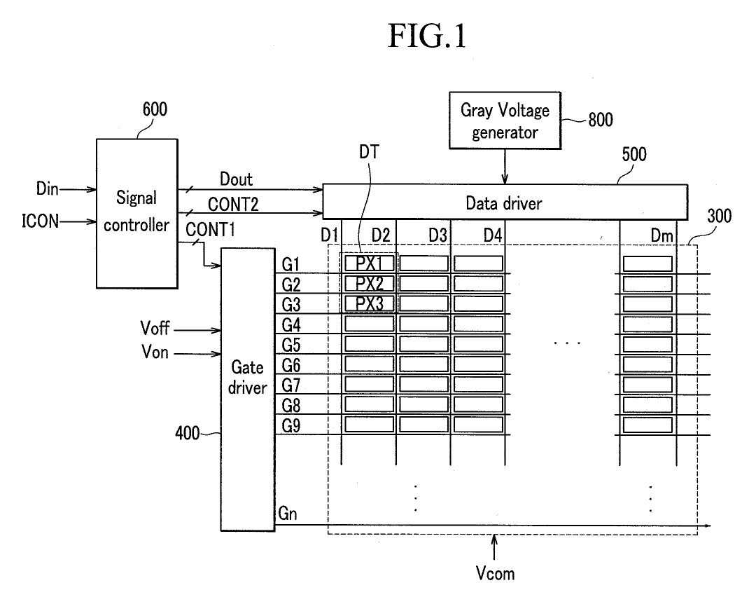

An exemplary embodiment of a liquid crystal display is described below with reference to FIG. 1 to FIG. 3.

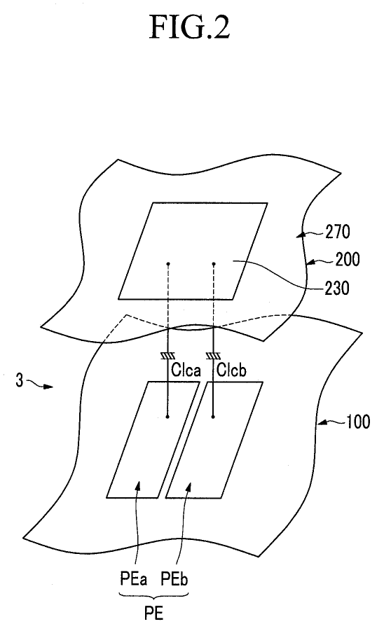

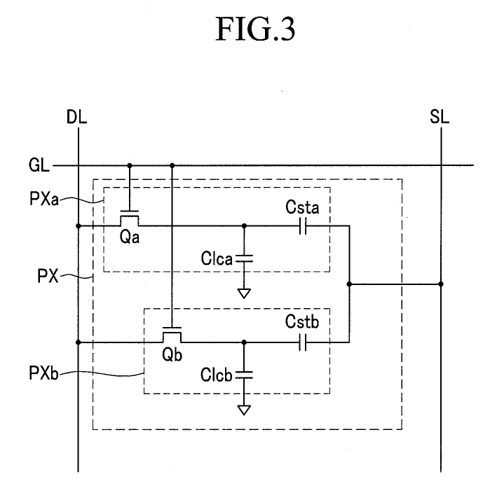

FIG. 1 is a block diagram of an exemplary embodiment of a liquid crystal display, FIG. 2 is a view showing a structure of an exemplary embodiment of a liquid crystal display, and FIG. 3 is an equivalent circuit diagram of two pixels of an exemplary embodiment of a liquid crystal display.

As shown in FIG. 1, an exemplary embodiment of a liquid crystal display may include a liquid crystal panel assembly 300, a gate driver 400, a data driver 500, a gray voltage generator 800, and a signal controller 600.

As viewed in an equivalent circuit, the liquid crystal panel assembly 300 includes a plurality of signal lines G1-Gn and D1-Dm, and a plurality of pixels PX1, PX2, and PX3 that are connected to the plurality of signal lines and disposed in a matrix form. Meanwhile, in a structure shown in FIG. 2, the liquid crystal panel assembly 300 includes lower and upper panels 100 and 200 that face each other, and a liquid crystal layer 3 interposed between the panels 100 and 200.

The signal lines G1-Gn and D1-Dm may include a plurality of gate lines G1a-Gnb that transmit gate signals (also referred to as “scanning signals”), and a plurality of data lines D1-Dm that transmit data signals. The gate lines G1-Gn substantially extend in a row direction to be parallel to each other, and the data lines D1-Dm substantially extend in a column direction to be parallel to each other.

Each of the pixels PX1, PX2, and PX3 may include a pair of subpixels, and may be connected to a storage electrode line as well as a gate line of the gate lines G1-Gn and a data line of the data lines D1-Dm. The storage electrode line SL transmits a storage electrode signal that is periodically changed. The storage electrode signal may be generated in a storage electrode driving circuit (not shown).

For example, referring to FIG. 3, the pixel PX may be connected to the gate line GL, the data line DL, and the storage electrode line SL and may include the first and second subpixels PXa and PXb.

Each of subpixels PXa and PXb includes a switching element Qa/Qb, a liquid crystal capacitor Clca/Clcb, and a storage capacitor Csta/Cstb.

Each switching element Qa/Qb may be a three-terminal element, such as a thin film transistor, provided on the lower panel 100. Each switching element Qa/Qb has a control terminal connected to the gate line GL, an input terminal connected to the data line DLa/DLb, and an output terminal connected to the liquid crystal capacitor Clca/Clcb and to the storage capacitor Csta/Cstb.

Referring to FIG. 2, the liquid crystal capacitors Clca/Clcb include two terminals, namely, subpixel electrodes 191a/191b, respectively, on the lower panel 100 and a common electrode 270 on the upper panel 200. The liquid crystal layer 3 between the two electrodes 191a/191b and 270 functions as a dielectric material. Two subpixel electrodes PEa and PEb are separated from each other and form one pixel electrode PE. The common electrode 270 may be formed on the whole surface of the upper panel 200 and may be applied with a common voltage Vcom. The liquid crystal layer 3 may have negative dielectric anisotropy. The liquid crystal molecules of the liquid crystal layer 3 may be aligned such that the long axis of the liquid crystal molecules may be arranged perpendicular to the surface of the display panels 100 and 200 when an electric field is not applied.

The voltage formed between two terminals of the liquid crystal capacitor Clca of the first subpixel PXa is generally higher than the voltage formed between two terminals of the liquid crystal capacitor Clcb of the second subpixel PXb.

The storage capacitor Csta/Cstb, which may serve as an assistant to the liquid crystal capacitor Clca/Clcb, may be formed as a storage electrode line SL on the lower display panel 100, overlapping the subpixel electrode 191a/191b with an insulator interposed therebetween. The capacitance of the storage capacitor Csta of the first subpixel PXa is smaller than the capacitance of the storage capacitor Cstb of the second subpixel PXb.

For color display, each pixel PX1, PX2, and PX3 uniquely represents one of three primary colors (i.e., spatial division) or each pixel PX1, PX2, and PX3 sequentially represents the three primary colors in turn (i.e., temporal division), such that a spatial or temporal sum of the primary colors is recognized as a desired color. An example of a set of the three primary colors includes red, green, and blue colors. FIG. 2 shows an example of the spatial division in which each pixel PX1, PX2, and PX3 includes a color filter 230 representing one of the primary colors in an area of the upper panel 200. In an alternative embodiment (not shown in FIG. 2), the color filter 230 may be provided on or under the subpixel electrodes PEa and PEb on the lower panel 100.

Hereafter, it is assumed that each color filter 230 represents one of red, green, and blue. The pixel having the red color filter 230 is referred to as a red pixel, the pixel including the green color filter 230 is referred to as a green pixel, and the pixel including the blue color filter 230 is referred to as the blue pixel. The red pixel, the blue pixel, and the green pixel are sequentially arranged in a column direction.

Referring to FIG. 1, each of pixels PX1, PX2, and PX3 is longer in a row direction than the column direction, and the pixels PX1, PX2, and PX3 of the three primary colors form one dot (DT) as a basic unit of an image display.

At least one polarizer (not shown) may be attached on the outer side of the display panels 100 and 200, and the polarization axes of the two polarizers may be crossed. In a reflective liquid crystal display, one of two polarizers may be omitted. In the case of the crossed polarizers, the light incident to the liquid crystal layer 3 is blocked in the absence of the application of the electric field.

Referring again to FIG. 1, the gray voltage generator 800 generates a plurality of gray voltages (or reference gray voltages) related to transmittance of the pixels PX.

The gate driver 400 may be connected to the gate lines of the liquid crystal panel assembly 300, and may apply gate signals Vg obtained by combining a gate-on voltage Von and a gate-off voltage Voff to the gate lines G1 to Gn.

The data driver 500 may be connected to the data lines of the liquid crystal panel assembly 300, and may select the gray voltages from the gray voltage generator 800 to apply them to the data lines D1 to Dm as data voltages. However, when the gray voltage generator 800 does not supply a voltage for all grays but supplies only a predetermined number of reference gray voltages, the data driver 500 divides the reference gray voltages to generate the data voltages for all of the grays and selects the data signals among them.

The signal controller 600 controls the gate driver 400 and the data driver 500.

Each of the drivers 400, 500, 600, and 800 may be installed directly on the liquid crystal panel assembly 300 in the form of at least one integrated circuit chip. Alternatively, each of the drivers 400, 500, 600, and 800 may be installed on a flexible printed circuit film (not shown) to be attached to the liquid crystal panel assembly 300 in the form of a tape carrier package (TCP) or installed on a separate printed circuit board (not shown). As a further alternative, the driving devices 400, 500, 600, and 800 may be directly integrated with the display panel 300. Further, the driving devices 400, 500, 600, and 800 may be integrated in a single chip. At least one of the driving devices, or at least one circuit element comprising the driving devices, may be disposed outside of the single chip in this case.

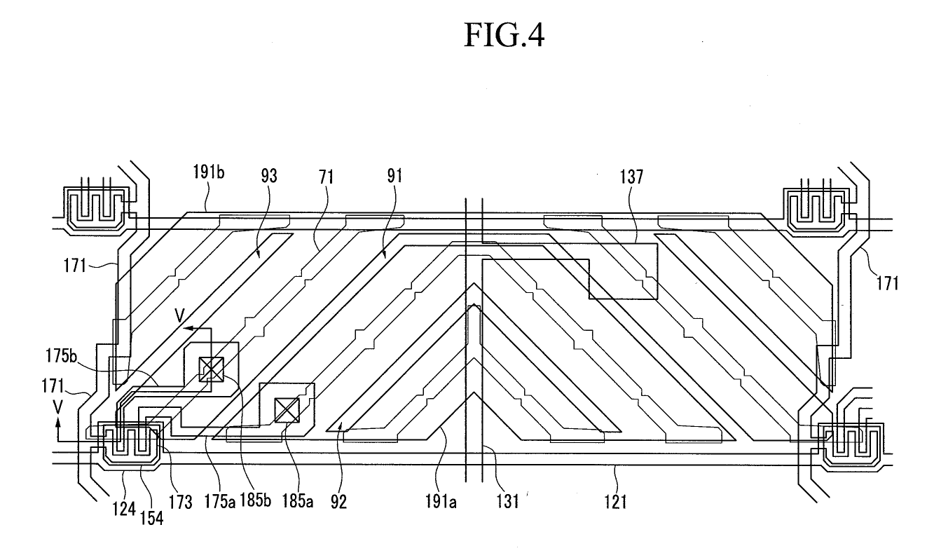

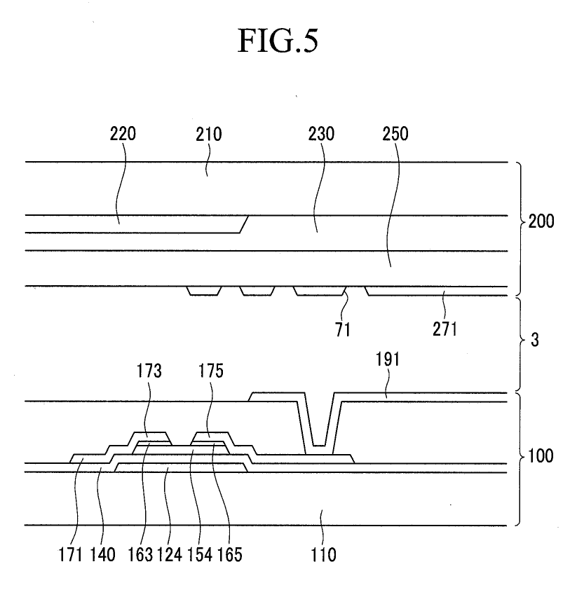

An exemplary embodiment of a liquid crystal panel assembly is described below with reference to FIG. 4 and FIG. 5.

FIG. 4 is a layout view of an exemplary embodiment of a liquid crystal panel assembly. FIG. 5 is a cross-sectional view of the liquid crystal panel assembly shown in FIG. 4 taken along the line V-V.

As shown in FIG. 5, a liquid crystal panel assembly according to the present exemplary embodiment includes the lower panel 100, the upper panel 200, and a liquid crystal layer 3 therebetween.

First, the lower panel 100 will be explained.

A gate line 121 may be formed on an insulating substrate 110 made of transparent glass or plastic. The gate line 121 includes a plurality of gate electrodes 124 protruding upward and downward.

A gate insulating layer 140, made, for example, of silicon nitride (SiNx) or silicon oxide (SiOx), is formed on the gate lines 121.

Semiconductor islands 154 that are made of hydrogenated amorphous silicon (a-Si) or polysilicon are formed on the gate insulating layer 140. Each semiconductor island 154 may be disposed on a gate electrode 124.

Ohmic contacts 163 and 165 are formed on the semiconductor islands 154. The ohmic contacts 163 and 165 are preferably made of silicide or n+ hydrogenated amorphous silicon in which an n-type impurity such as phosphorus is highly doped.

A data line 171, first and second drain electrodes 175a and 175b, and a storage electrode line 131 are formed on the ohmic contacts 163 and 165 and the gate insulating layer 140.

The data lines 171 intersect the gate lines 121, and are bent at least once between two neighboring gate lines 121. Each data line 171 includes a source electrode 173 extending to the right side or the left side toward the gate electrode 124, thereby being curved with a “W” shape. The data line 171 may be bent adjacent to the source electrode 173.

The first and second drain electrodes 175a and 175b are separated from the data line 171 and face the source electrode 173 with respect to the gate electrode 124. Each of the drain electrodes 175a and 175b includes one end portion having a wide area and the other end portion having a bar shape. The bar end portion is enclosed by the curved portion of the source electrode 173.

A gate electrode 124, a source electrode 173, and a drain electrode 175a/175b form a thin film transistor TFT along a semiconductor island 154. The channel of the thin film transistor Q is formed in the semiconductor island 154 between the source electrode 173 and the drain electrode 175.

The storage electrode line 131 extends substantially parallel with the data line 171, maintaining generally the same distance from two neighboring data lines 171. The storage electrode line 131 may extend in one direction and may include a protrusion 137 having a wide end portion.

The ohmic contacts 163 and 165 are interposed only between the underlying semiconductor islands 154 and the overlying data lines 171 and the drain electrodes 175 thereon, reducing contact resistance therebetween. The semiconductor islands 154 include exposed portions that are not covered by the source electrodes 173 and the drain electrodes 175 and 175b, and portions that are disposed between the data lines 171 and the drain electrodes 175a and 175b.

A passivation layer 180 may be formed on the data lines 171, the drain electrodes 175a and 175b, the storage electrode lines 131, and the exposed semiconductor islands 154.

The passivation layer 180 may be made of an inorganic insulator or an organic insulator, and may have a flat surface. The passivation layer 180 has a plurality of contact holes 185a and 185b exposing the drain electrodes 175a and 175b. The contact holes 185a and 185b are disposed on the protrusions 137 of the storage electrode lines 131 and the opposite side thereof with respect to the storage electrode line 131 to balance the aperture ratio and the visibility of the left and right sides in the pixel.

A pixel electrode 191 may be formed on the passivation layer 180. The pixel electrode 191 may be made of a transparent conductive material such as ITO or IZO, or a reflective metal such as aluminum, silver, chromium, or alloys thereof.

The pixel electrode 191 has an approximately quadrangle shape having four chamfered corners. The chamfered edges of the pixel electrode 191 form an angle of about 45 degrees with the gate lines 121.

The pixel electrode 191 may be divided into the first and second subpixel electrodes 191a and 191b by a gap 91 disposed therebetween.

The first subpixel electrode 191a has an approximate isosceles trapezoid shape. The central portion of the lower edge may be recessed. The first subpixel electrode 191a overlaps the storage electrode line 131, and has a symmetrical shape with respect to the storage electrode line 131.

The second subpixel electrode 191b includes two electrode pieces disposed outside the oblique edges of the first subpixel electrode 191a, and a connection for connecting the two electrode pieces to each other. The electrode pieces have an approximate right trapezoid shape. The connection has a straight shape and intersects the storage electrode line 131. One of the two electrode pieces overlaps the wide portion of the protrusion 137 of the storage electrode line 131. The second subpixel electrode 191b may be symmetrical with respect to the storage electrode line 131.

A difference (hereafter referred to as “first pixel voltage”) between the voltage of the first subpixel electrode 191a and the common voltage is larger than a difference (referred to as “second pixel voltage”) between the voltage of the second subpixel electrode 191b and the common voltage.

The overlapping area between the second subpixel electrode 191b and the storage electrode line 131 is larger than the overlapping area between the first subpixel electrode 191a and the storage electrode line 131, and accordingly the capacitance of the storage capacitor formed by the overlapping of the second subpixel electrode 191b and the storage electrode line 131 is larger than the capacitance of the capacitor formed by the overlapping of the first subpixel electrode 191a and the storage electrode line 131.

The shortest distance between the second subpixel electrode 191b and the data line 171 is shorter than the shortest distance between the first subpixel electrode 191a and the data line 171. Also, for an embodiment, a substantial portion of the data line 171 may overlap the second subpixel electrode 191b.

In this way, if the subpixel electrode having the lower relative voltage for the common voltage is disposed outside, the change in the amount of the luminance due to the parasitic capacitance between the data line 171 and the subpixel electrode may be reduced. The voltage difference between the grays in the low grays and the voltage difference between the grays in the high grays may be different. For example, the voltage difference between the neighboring low grays is larger than the voltage difference between the neighboring high grays. Although the change in the amount of the voltage of the subpixel electrode due to the parasitic capacitance along with the data line 171 is the same, the change in the amount of the luminance when the subpixel electrode displays the low gray is smaller than the change amount of the luminance when displaying the high gray, for example extremely smaller.

Also, this arrangement increases the area of the pixel electrode 191, thereby increasing the aperture ratio while not increasing the change amount for the same luminance due to the parasitic capacitance between the data line 171 and the subpixel electrode. If the area of the pixel electrode 191 is increased, the distance between the subpixel electrode and the data line 171 is reduced such that the change in the amount of the voltage due to the parasitic capacitance is increased, however the corresponding subpixel electrode displays the low gray in place of the high gray such that the change in the amount of the luminance for a unit voltage is reduced.

The first and second subpixel electrodes 191a and 191b, respectively, may include cutouts 92 and 93 forming an oblique angle with the gate line 121 and the data line 171. The gap 92 may include an oblique portion substantially parallel to the cutouts 92 and 93.

Next, the upper panel 200 is described below.

A light blocking member 220 may be formed on an insulating substrate 210 made of a material such as transparent glass or plastic. The light blocking member 220 may be called a black matrix, and may prevent light leakage between the pixel electrodes 191.

A color filter 230 may be formed on the substrate 210. The color filter 230 may be disposed primarily in the region enclosed by the light blocking member 230, and may extend in a direction corresponding to the column of the pixel electrodes 191, for example in the longitudinal direction.

An overcoat 250 may be formed on the color filter 230 and the light blocking member 220. The overcoat 250 may be made of an (organic) insulating material, and may prevent the color filters 230 from being exposed and may provide a generally flat surface. The overcoat 250 may be omitted.

A common electrode 270 may be formed on the overcoat 250. The common electrode 270 may be made of a transparent conductor such as ITO or IZO and may include a plurality of cutouts 71. The cutouts 71 of the common electrode 270 may include a portion parallel to the cutouts 92 and 93 or the gap 91 of the pixel electrode 191, and may be alternately disposed.

In this liquid crystal display, the drain electrodes 175a and 175b, the contact holes 185a and 185b, the storage electrode lines 131, the protrusions 137, and the cutouts 91-93 and 71 may function as elements that reduce the aperture ratio. The protrusions 137, the drain electrodes 175a and 175b, and the contacts hole 185a and 185b may be disposed on opposite sides to balance the aperture ratio and the visibility of the right side and the left side of the pixel, as described above. Furthermore, the right and left widths of the cutouts 91-93 and 71 may be controlled. For example, in an example embodiment in which the protrusions 137, the drain electrodes 175a and 175b, and the contact holes 185a and 185b are disposed on opposite sides, if the aperture ratio of the right side of the pixel is small, the right width of the cutout may be reduced to balance the aperture ratio.

Next, the operation of this liquid crystal display is described below with reference to FIG. 6 and FIG. 1 to FIG. 5.

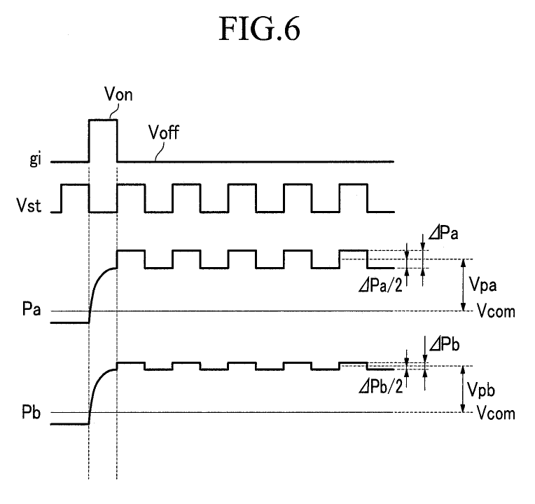

FIG. 6 is a waveform diagram of voltages in an exemplary embodiment of a liquid crystal display.

Referring again to FIG. 1, the signal controller 600 may receive an input image signal Din and may receive an input control signal ICON, for controlling the display of the 5 input image signal Din, from an external graphics controller (not shown). The input image signal Din may contain luminance information of each pixel PX. The luminance may have grays of a given quantity, for example 1024=2¹⁰, 256=2⁸, or 64=2⁶. The input control signal ICON may include, for example, a vertical synchronization signal, a horizontal synchronizing signal, a main clock signal and a data enable signal.

The signal controller 600 may process the input image signal Din, as appropriate, to correspond to an operating condition or conditions of the display panel 300 based on the input image signal Din and the input control signal ICON. The signal controller 600 may also generate a scanning control signal CONT1 and a data control signal CONT2. The signal controller 600 may send the scanning control signal CONT1 to the gate driver 400, and send the data control signal CONT2 and the processed output image signal Dout to the data driver 500. The output image signal Dout may have values (or grays) of the predetermined number as a digital signal.

According to the data control signal CONT2 from the signal controller 600, the data driver 500 receives the digital image signal Dout for the pixel PX of one row, selects the gray voltage corresponding to each digital image signal Dout to convert the digital image signal Dout into the analog image data signal, and applies the converted signal to the corresponding image data lines D1-Dm.

The gate driver 400 applies the gate-on voltage Von to the gate lines G1-Gn according to the image scan control signal CONT1 from the signal controller 600 to turn on the switching elements Qa and Qb connected to the gate lines G1-Gn. The data signal applied to the data lines D1-Dm is then applied to corresponding subpixels PXa and PXb through turned-on switching elements Qa and Qb.

Two subpixels PXa and PXb forming one pixel PX may have the same data voltage applied at the same time through the same data line D1-Dm.

For convenience of explanation, one terminal that is connected to the switching elements Qa and Qb among two terminals of each capacitor Clca, Clcb, Csta, and Cstb may be referred to as a first terminal, and the other terminal may be referred to as a second terminal. As above-described, the first terminals of the liquid crystal capacitors Clca and Clcb and the corresponding storage capacitors Csta and Cstb may be connected to each other.

Referring to FIG. 6, voltages Pa and Pb of the first terminal may be increased identically to a predetermined level in a pixel PX1.

If the switching elements Qa and Qb are turned off, the first terminals of each capacitor Clca, Clcb, Csta, and Cstb may become floated. Since the gate voltage Vgi is transformed to a gate-off voltage Voff at a gate-on voltage Von, the first terminal voltages Pa and Pb may decrease as much as a kickback voltage (not shown).

On the other hand, as shown in FIG. 6, the storage voltage Vst of the storage electrode line SL connected to the second terminal of the storage capacitors Csta and Cstb may be changed with twice the period of the gate-on voltage Von such that the first terminal voltages Pa and Pb are also changed. For example, as in FIG. 6, the storage voltage Vst may be increased immediately after each capacitor Clca, Clcb, Csta, and Cstb is charged with the voltage of the positive polarity for the common voltage Vcom, such that the first terminal voltages Pa and Pb also increase. Since the capacitances of two storage capacitors Csta and Cstb are different from each other, the increasing width of the first terminal voltage Pa and the second terminal voltage Pb are different from each other.

The variation ΔPk of the first terminal voltage Pk (k=a, b) is proportional to Cstk/(Ct+Cstk). Here, Ct denotes the capacitance of the other capacitor connected to the first terminal. For example, if Csta is larger than Cstb, ΔPa becomes larger than ΔPb because Csta/(Ct+Csta)>Cstb/(Ct+Cstb) as shown in FIG. 6.

The storage voltage Vst may be repeatedly increased and decreased during one frame such that the second terminal voltages Pa and Pb is repeatedly increased and decreased. Accordingly, the second terminal voltages Pa and Pb may be increased by ΔPa/2 and ΔPb/2 during one frame on average. The voltages Pa and Pb of the liquid crystal capacitors Clca and Clcb are changed through this process.

If the potential difference is generated between both ends of the liquid crystal capacitors Clca and Clcb, the electric field is formed on the liquid crystal layer 3. Then, the major axes of the liquid crystal molecules of the liquid crystal layer 3 incline in response to the electric field, and polarization of inclined light entering the liquid crystal layer 3 varies according to an inclining degree of the liquid crystal molecules. The polarization variation is expressed as transmittance variation by a polarizer, and the liquid crystal display displays an image through the transmittance variation.

The inclined angle of the liquid crystal molecule may vary according to the intensity of the electric field because the voltages of two liquid crystal capacitors Clca and Clcb are different. Accordingly, two subpixels PXa and PXb may have different luminance. Therefore, if capacitances of the two storage capacitors Csta and Cstb are properly matched with each other, it is possible to make an image seen from a lateral side maximally close to an image seen from a frontal side. That is, it is possible to make a lateral gamma curve maximally close to a frontal gamma curve. Therefore, lateral visibility may be improved.

Data voltages Vd may be applied to all of pixels PX by repeating the above-described processes with one horizontal period (1H) as a unit. As a result, an image of one frame may be displayed. In this case, the one horizontal period may be identical to one period of a horizontal synchronizing signal Hsync and a data enable signal DE.

After one frame ends, the next frame starts. A state of an inverse signal (RVS), which is applied to the data driver 500, may then be controlled to make the polarity of the data voltage Vd applied to each pixel PX opposite to the polarity of the previous frame.

The polarity of the data voltage applied to each pixel PX may change conversely at the next frame, and the polarities of the storage electrode signals are also changed such that the direction of the change voltages ΔPa and ΔPb are converse.

As described above, the luminance of two subpixels may be separately controlled while applying the same voltage to storage capacitors of two subpixels in one pixel.

Within one frame, on the other hand, the polarity of the data voltage flowing through one data line may be periodically changed according to characteristics of the inversion signal RVS (e.g., row inversion and dot inversion), or the polarities of the data voltage applied to one pixel row may be different (e.g., column inversion and dot inversion).

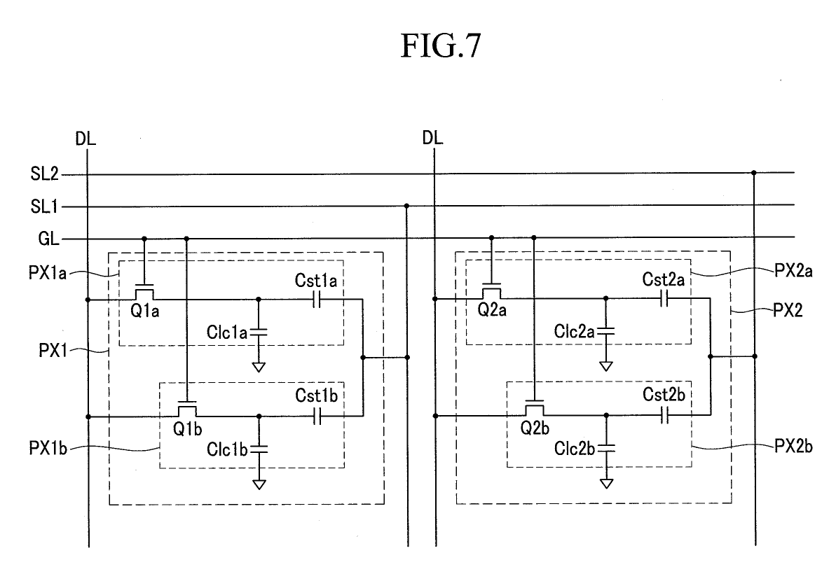

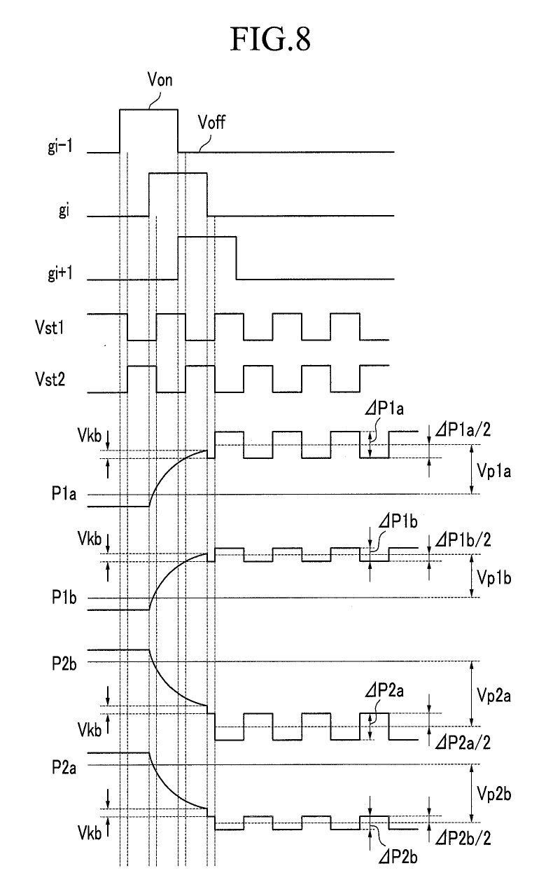

In the case of the dot inversion in particular, the polarities of two neighboring pixels may be opposite in the same row such that the storage voltages applied to two pixels must be in a reversed state to each other. Such an exemplary embodiment is described below, with reference to FIG. 7 and FIG. 8.

FIG. 7 is an equivalent circuit diagram of two pixels of an exemplary embodiment of a liquid crystal display. FIG. 8 is a waveform diagram of voltages of the exemplary embodiment of the liquid crystal display shown in FIG. 7.

Referring to FIG. 7, storage capacitors Cst1a, Cst1b, Cst2a, and Cst2b of two neighboring pixels PX1 and PX2 may be connected to different storage electrode lines SL1 and SL2. Referring to FIG. 8, the storage voltages Vst1 and Vst2 applied to two storage electrode lines SL1 and SL2 may have opposite polarities to each other and may be signals having a period of two horizontal periods. Accordingly, the change directions of the voltages of two neighboring pixels PX1 and PX2 may be opposite. For example, if the voltages P1a and P1b of one pixel PX1 charged with the positive polarity are increased, the voltages P2a and P2b of the other pixel PX2 charged with the negative polarity are decreased. In FIG. 8, ΔP1a, ΔP1b, ΔP2a, are ΔP2b are voltage variation amplitudes of the liquid crystal capacitors Clc1a, Clc1b, Clc2a, and Clc2b, respectively, and V1pa, V1pb, V2pa, and V2pb are average increasing/decreasing widths of the voltages of the liquid crystal capacitors Clc1a, Clc1b, Clc2a, and Clc2b, respectively.

Referring to FIG. 1, on the other hand, the long edge of the pixel PX may be parallel to the row direction such that the number of pixel rows is large. Accordingly, it may be difficult to sequentially and sufficiently charge the many pixel rows during the time of one frame. Accordingly, as shown in FIG. 8, the gate-on voltage Von interval of two continuous gate signals of gᵢ₋₁, gᵢ, and gᵢ₊₁ overlap as a precharging concept. Therefore, each pixel PX1 and PX2 may receive the data voltage of the previous pixel row during the first half of the gate-on voltage Von interval, and may receive its own data voltage during the latter half.

The data voltage may change for one horizontal period, and the changing time point may be approximately in accord with the time that the storage voltages Vst1 and Vst2 are increased or decreased. To block the input of the data voltage of the next pixel row, the gate signal gi may be changed into the gate-off voltage Voff slightly before the input of the data voltage of the next pixel row. Accordingly, the changing time point of the gate signal gi and the changing time point of the storage voltages Vst1 and Vst2 may differ slightly, and the voltage charged to the liquid crystal capacitors Clc1a, Clc1b, Clc2a, and Clc2b and the storage capacitors Cst1a, Cst1b, Cst2a, and Cst2b may be maintained with the state that is decreased by the kickback voltage Vkb.

In an exemplary embodiment, the change of the luminance due to the parasitic capacitance of the pixel electrode and the data line may be reduced and the aperture ratio may be increased.

While the subject matter of this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A liquid crystal display comprising:
a gate line extending in a first direction;
a data line intersecting the gate line and extending in a second direction;
a first switching element connected to the gate line and the data line;
a second switching element connected to the gate line and the data line;
a first subpixel electrode connected to the first switching element and having a first voltage; and
a second subpixel electrode connected to the second switching element and having a second voltage,
wherein the difference between the first voltage and a common voltage is larger than the difference between the second voltage and the common voltage, and
the shortest distance between the first subpixel electrode and the data line is larger than the shortest distance between the second subpixel electrode and the data line.

2. The liquid crystal display of claim 1, wherein
the first subpixel electrode and the second subpixel electrode together have a generally rectangular combined shape having a long edge in the first direction.

3. The liquid crystal display of claim 2, further comprising
a storage electrode line overlapping the first and second subpixel electrodes,
wherein an overlapping area between the first subpixel electrode and the storage electrode line is smaller than an overlapping area between the second subpixel electrode and the storage electrode line.

4. The liquid crystal display of claim 3, wherein
the data line transmits a data voltage with the positive or negative polarities for the common electrode, and
a storage electrode line voltage is repeatedly increased and decreased, and a voltage value of the storage electrode line voltage varies in the same direction as the polarity of the data voltage after the data voltage is applied to the first and second subpixel electrodes.

5. The liquid crystal display of claim 4, wherein
the second subpixel electrode overlaps the data line.

6. The liquid crystal display of claim 5, wherein
the data line is bent, thereby varying the distance between the second subpixel electrode and the data line.

7. The liquid crystal display of claim 6, wherein
the data line includes a first portion overlapping the second subpixel electrode and a second portion not overlapping the second subpixel electrode.

8. The liquid crystal display of claim 4, wherein
the storage electrode line extends in the second direction.

9. The liquid crystal display of claim 8, wherein
the storage electrode line includes a protrusion overlapping the second subpixel electrode.

10. The liquid crystal display of claim 9, further comprising
a contact portion for connecting the first and second switching elements and the first and second subpixel electrodes,
wherein the contact portion and the protrusion are disposed on opposite sides with respect to the storage electrode line.

11. The liquid crystal display of claim 9, wherein
the first subpixel electrode is arranged generally as an isosceles trapezoid, and
the second subpixel electrode is disposed outside two oblique edges of the first subpixel electrode and includes two electrode pieces with right trapezoidal shapes arranged in symmetry.

12. The liquid crystal display of claim 11, wherein
the first subpixel electrode and the second subpixel electrode are respectively symmetrical with respect to the storage electrode line.

13. The liquid crystal display of claim 12, wherein
at least one of the first subpixel electrode and the second subpixel electrode has a cutout extending in a direction forming an oblique angle with the first and second directions.

14. The liquid crystal display of claim 13, wherein
a right width and a left width of the cutout are different with respect to the storage electrode line.

15. A liquid crystal display comprising:
a gate line extending in a first direction;
a data line intersecting the gate line and extending in a second direction;
a storage electrode line extending in the second direction and having a voltage of varying magnitude applied to it;
a first switching element connected to the gate line and the data line;
a second switching element connected to the gate line and the data line;
a first liquid crystal capacitor connected to the first switching element and having a first voltage;
a second liquid crystal capacitor connected to the second switching element and having a second voltage;
a first storage capacitor connected between the first switching element and the storage electrode line; and
a second storage capacitor connected between the second switching element and the storage electrode line and having a larger capacitance than the first storage capacitor,
wherein the first liquid crystal capacitor includes a first subpixel electrode connected to the first switching element,
the second liquid crystal capacitor includes a second subpixel electrode connected to the second switching element and separated from the first subpixel electrode via a gap, and wherein
the shortest distance between the first subpixel electrode and the data line is longer than the shortest distance between the second subpixel electrode and the data line.

16. The liquid crystal display of claim 15, wherein
the first subpixel electrode and the second subpixel electrode together have a generally rectangular combined shape having a long edge in the first direction.

17. The liquid crystal display of claim 16, wherein
The voltage applied to the storage electrode line repeatedly varies, and a value of the voltage applied to the storage electrode line varies in the same direction as a voltage polarity of the first and second liquid crystal capacitors immediately after the first and second liquid crystal capacitors are charged.

18. The liquid crystal display of claim 17, wherein
the second subpixel electrode overlaps the data line.

19. The liquid crystal display of claim 18, wherein
the data line is bent, thereby varying the distance between the second subpixel electrode and the data line.

20. The liquid crystal display of claim 19, wherein
the data line includes a first portion overlapping the second subpixel electrode and a second portion not overlapping the second subpixel electrode.
